(19) United States
(12) Patent Application Publication
(10) Pub. No.: US 2002/0136804 A1
(43) Pub. Date: Sep. 26, 2002

(54) Packaged, multi-layered, ready-to-eat puddings

(76) Inventors: Lorraine A. Hoffmann, Ramsey, NJ (US); Richard R. Leshik, Brookfield, CT (US)

Correspondence Address: LARSON & TAYLOR, PLC, 1199 NORTH FAIRFAX STREET, SUITE 900, ALEXANDRIA, VA, 22314, US

(21) Appl. No.: 10/113,981

(22) Filed: Apr. 2, 2002

Related U.S. Application Data
(63) Continuation of application No. 09/596,722, filed on Jun. 19, 2000.
(60) Provisional application No. 60/140,569, filed on Jun. 23, 1999.

(51) Int. Cl. C12C 1/027

(52) U.S. Cl. 426/106

(57) ABSTRACT

In layered, ready-to-eat pudding products containing adjacent layers of a dark-colored pudding, such as chocolate and a light-colored pudding, such as vanilla, the appearance of color migration from the dark layer into the light layer is eliminated by incorporating of 0.4% or more by weight of a whitening pigment, such as titanium dioxide, in the light-colored pudding. The problem overcome by this invention is of concern when the layered pudding is packaged in clear or translucent plastic cups and particularly when the pudding product is a shelf-stable product.

This application claims the benefit of U.S. provisional application Ser. No. 60/140,569 filed Jun. 23,1999. This is a continuation of application Serial No. 09/596,722, filed Jun. 19, 2000.

### BACKGROUND OF THE INVENTION

Consumers have in recent times been desirous of eating wholesome and nutritious snack foods. Milk-containing puddings have long been considered nutritious and wholesome foods. Consumers are, however, requiring that the foods they eat, particularly snack food and dessert items, be essentially ready-to-eat. Thus, the amounts of cooked puddings and even instant puddings prepared in the home environment has been decreasing in recent years.

To fill the desire of consumers for pudding dessert or snack items which require no preparation on the part of the consumer, there exists ready-to-eat puddings which are usually marketed in single-service portions. Ready-to-eat puddings are currently available as aseptic, shelf-stable products and pasteurized or commercially-sterile refrigerated products.

These products were initially marketed as single flavor puddings, such as all chocolate or all vanilla. However, a desire to provide consumers with more variety has led to the production and marketing of multi-layered pudding products. As ready-to-eat pudding products are usually packaged in clear or translucent plastic cups, it is desirable to have a clear line of demarcation between adjacent differently-colored pudding layers. Adjacent layers of chocolate and vanilla puddings would present one of the extreme problems for having a dark-colored pigment, such as cocoa, bleed into a lighter-colored layer. As might be expected, the problem with pigment or color migration increases with the length of storage time and with increased storage temperature.

### SUMMARY OF THE INVENTION

It has been found that the perceived color migration from adjacent layers of darker-colored and lighter-colored, ready-to-eat puddings can be obviated by incorporating a high level of an inorganic whitening pigment, such as titanium dioxide, in the lighter-colored pudding formulation. Although whitening pigments such as titanium dioxide, are known for use as whiteners for puddings, the typical use level has been significantly below 0.4% by weight of the pudding formulation.

The use of titanium dioxide as a whitener in pudding, has been largely directed to low-fat and fat-free puddings where titanium dioxide is employed in order to add back the opacity which fat is known to provide.

According to this invention, white pigments, such as titanium dioxide, at a level of 0.4% or more by weight are incorporated into the lighter-colored pudding formulation of a layered pudding product comprised of a layer of lighter-colored pudding adjacent to a layer of a darker-colored pudding. The desired effect is directly proportional to the level of titanium dioxide employed. The higher the level of pigment, the longer the period visible color migration is absent. Levels in excess of 0.5% by weight of the pudding are typically employed. Preferably, the level of titanium dioxide in the pudding at least 0.6%, more preferably from 0.6-1% by weight.

The white pigment material preferred for use in this invention is conventional and commercially-available titanium dioxide, wherein substantially all particles are less than one micron and wherein a majority of particles are between 0.2 and 0.3 microns. As will be recognized by those skilled in the art, pigment material, which has a particle size less than the conventional material will have a greater whitening power per unit weight. Therefore, the levels of white pigment specified for use in this invention relate to conventional-sized pigment. Of course, as again will be recognized by those skilled in the art, at extreme fineness the whitening power of these particles will become non-existent.

The pigment-containing pudding may have a fat content in excess of 1.5% by weight for low-fat puddings, in excess of 2.5% by weight for reduced fat puddings or in excess of 3.0% by weight for full-fat puddings. This invention is well-suited for the production of layered, shelf-stable ready-to-eat puddings which typically require shelf-life stability in excess of six months and which may encounter storage temperatures well above 70° F. (21.1° C.). As might be expected, the speed of color migration is affected by storage temperature, with color migration being accelerated at higher storage temperatures. Of course, this invention could also be applied in the production of layered, refrigerated, ready-to-eat puddings.

The effect of gravity will also influence the rate of color migration. Thus migration from an upper layer to a lower layer will be more rapid than migration from a lower layer to an upper layer. This invention is therefore well-suited for use in a pudding product with a chocolate upper layer and a vanilla lower layer. Other combinations of color-contrasting pudding layers, such as rocky road and marshmallow, vanilla and banana, are contemplated for use with this invention.

### EXAMPLE

Vanilla and chocolate puddings were prepared according to the following formulas (parts by weight).

| INGREDIENT | VANILLA | CHOCOLATE |
|---|---|---|
| Water | 70.4 | 70.7 |
| Sugar | 14.6 | 14.4 |
| Non-Fat Dry Milk | 3.5 | 3.2 |
| Soybean Oil | 4.0 | 3.6 |
| Modified Waxy Maize Starch | 3.0 | 2.9 |
| Modified Corn Starch | 2.0 | 1.9 |
| Salt | 0.2 | 0.3 |
| Sodium Stearyol Lactylate | 0.2 | 0.2 |
| Vanilla flavor/color | 0.1 | — |
| Cocoa | — | 2.7 |
| Titanium Dioxide/Carrier (50/50) | 2.0 | — |
| Chocolate Flavor | — | 0.1 |

Vanilla and chocolate puddings were prepared in a conventional manner in accordance with the above formulations. Each formulation is sterilized using UHT conditions, cooled and then aseptically filled into clear, single-serving plastic cups with the bottom ⅔ fill level being vanilla and the top ⅓ fill level being chocolate. After two months of room temperature storage, color migration from the chocolate layer to the vanilla layer is masked and visually appealing. A comparable, layered pudding product, without any titanium dioxide ingredient, evidences visual color migration from the chocolate layer through the vanilla layer making the vanilla layer brown and visually unappealing.

We claim:

1. A method for preventing dye migration into a lighter-colored pudding from a darker pigment containing composition, said method comprising:
adding a level of inorganic whitening pigment to a lighter-colored pudding in a sufficient amount to retard pigment present in a darker-colored composition from migrating into the lighter-colored pudding.

2. The method of claim 1, wherein the pigment in added in an amount of 0.4% or more by weight.

3. The method of claim 1, wherein the darker-colored composition is a darker-colored pudding adjacent the lighter-colored pudding.

4. The method of claim 3, further comprising layering the lighter-colored pudding on the darker-colored pudding.

5. The method of claim 3, further comprising layering the darker-colored pudding on the lighter-colored pudding.

6. The method of claim 3, further comprising placing the lighter-colored pudding along side the darker-colored pudding.

7. The method of claim 1, wherein the pigment level is 0.6 or more.

8. The method of claim 1, wherein the pigment comprises titanium dioxide.

9. The method of claim 1, wherein the light-colored pudding has a fat content in excess of 1.5% by weight.

10. The method of claim 1, wherein the light-colored pudding has a fat content in excess of 2.5% by weight.

11. The method of claim 1, wherein the light-colored pudding has a fat content in excess of 3% by weight.

12. A method for preparing a multi-colored pudding product having a lighter-colored pudding which retards dye migration from a darker-colored pudding; said method comprising:
adding a level of inorganic whitening pigment to a lighter-colored pudding in a sufficient amount to retard dye migration from a darker-color pudding; and
placing the lighter-color pudding adjacent the darker-colored pudding.

13. The method of claim 12, wherein the pigment in added in an amount of 0.4% or more by weight.

14. The method of claim 12, wherein said placing the lighter-color pudding adjacent the darker-colored pudding comprises layering the lighter-colored pudding on the darker-colored pudding.

15. The method of claim 12, wherein said placing the lighter-color pudding adjacent the darker-colored pudding comprises layering the darker-colored pudding on the lighter-colored pudding.

16. The method of claim 12, placing the lighter-colored pudding along side the darker-colored pudding.

17. The method of claim 12, wherein the pigment level is 0.6 or more.

18. The method of claim 12, wherein the pigment comprises titanium dioxide.

19. The method of claim 12, wherein the light-colored pudding has a fat content in excess of 1.5% by weight.

20. The method of claim 12, wherein the light-colored pudding has a fat content in excess of 2.5% by weight.

21. The method of claim 12, wherein the light-colored pudding has a fat content in excess of 3% by weight.
